(19) United States
(12) Patent Application Publication
(10) Pub. No.: US 2007/0161361 A1
(43) Pub. Date: Jul. 12, 2007

(54) Interference rejection in telecommunication system

(75) Inventors: Petri Vaisanen, Kempele (FI); Olli Piirainen, Oulu (FI); Markku Vainikka, Kiviniemi (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/357,084

(22) Filed: Feb. 21, 2006

(30) Foreign Application Priority Data
Jan. 9, 2006 (FI) 20065010

(51) Int. Cl. H04B 1/00; H04B 1/18; H04B 1/10

(52) U.S. Cl. 455/302; 455/285; 455/63.1; 455/278.1

(57) ABSTRACT

An interference suppression scheme is provided for a radio receiver. According to the provided interference suppression scheme, the bandwidth of a received pilot signal and a data signal is divided into a plurality of frequency sub-bands. The pilot signal and the data signal have been transmitted according to single carrier data transmission technology. Interference parameters are calculated for each frequency sub-band separately. Interference suppression may be carried out jointly or separately for each frequency sub-band. After the interference suppression, the frequency sub-bands are combined. A filter bank may be used for dividing the total frequency band into sub-bands.

### FIELD

The invention relates generally to signal processing in a telecommunication system and particularly to interference suppression in a radio receiver.

### BACKGROUND

In a co-channel communication system with frequency reuse, the received signal typically comprises a number of co-channel signals that have propagated through independent multi-path fading channels. Usually, the optimum maximum a posteriori probability (MAP) based sequence estimation for the joint detection of the co-channel signals is computationally too complex. Thus, typically a sub-optimal solution is more advantageous. Such an alternative solution is interference rejection combining (IRC) in which the signals received by the multiple antennas at the receiver are weighted and combined in order to maximize the output signal-to-interference-and-noise ratio (SINR). With IRC, spatial diversity can also be used to reduce the co-channel interference (CCI) at the receiver.

The IRC attempts to suppress the interfering co-channel signals by treating them as spatially and temporally colored noise and, contrary to the optimum MAP sequence estimation, to detect only the desired signal by using the plurality of antennas at the receiver. The insight in the IRC is that the interference signals are correlated with each other since the same spatially nonuniformly distributed interference signals are received through all antennas of the receiver. This correlated interference can be thought as colored noise with a given correlation matrix.

FIG. 1 illustrates a prior art IRC solution. A pilot signal and a data signal are received in a radio receiver through a reception antenna and filtered in a pulse shaping filter 100, which is adapted for a pulse shape used in the transmission of the pilot signal and the data signal (typically a square root raised cosine pulse shape). The received pilot signal and the data signal are converted into a base band or to an intermediate frequency in a mixer 102, which multiplies the signals by a signal f(n) having a given central frequency. Additionally, the signals are filtered and analog-to-digital (A/D) converted (not shown). The received pilot signal s′(n) and the received data signal y′(n) are extracted in block 104. The received pilot signal s′(n) comprising the transmitted pilot signal having propagated through a fading radio channel, interference caused by other signals on the same frequency band, and noise is fed to a channel estimation block 106 together with a clean pilot signal produced in the radio receiver. The channel estimation block produces a channel impulse response signal h(n), which is fed to a pilot signal estimation block 108. The pilot signal estimation block produces an estimate of the transmitted pilot signal propagated through the radio channel by using the known pilot signal s(n) and the channel impulse response signal. The idea is to produce a replica of the pilot signal which comprises no interference caused by the other signal on the same frequency band, i.e. the replica comprises only channel induced interference and noise. This replica of the pilot signal is then subtracted from the received pilot signal s′(n) in an adder 110, resulting in an interference signal e(n) comprising co-channel interference signal and noise. The interference signal e(n) is fed to an IRC block 112 together with the received data signal y′(n). The IRC block 112 estimates interference parameters (typically by calculating a covariance matrix) and processes the received data signal by attempting to whiten the spectrum of the received data signal. The IRC block 112 may be an interference cancellation block and the actual combining may be carried out in the later stages, for example through a maximal ratio combining (MRC) scheme. In this case, the MRC may be carried out after equalization of the received data signal. Alternatively, the MRC may be carried out in the IRC block 112 and the equalization may be carried out thereafter.

In current and future broadband wireless mobile systems, the transmission bandwidths can be variable and, thus, the symbol rate high, which results in a highly frequency selective channel. This causes severe inter-symbol-interference (ISI). In order to overcome the ISI as well as other interference types, the number of channel parameters and the number of parameters to be estimated by the IRC and the channel equalizer types of receivers increase. In this case, the gain obtained through the conventional IRC or through a spatio-temporal IRC (ST-IRC) is typically small, resulting in a reduced quality of data transmission.

### BRIEF DESCRIPTION OF THE INVENTION

An object of the invention is to provide an improved solution for interference suppression in a radio receiver.

According to an aspect of the invention, there is provided an interference suppression method in a radio receiver. The method comprises receiving a pilot signal and a data signal that have been transmitted according to a single carrier transmission scheme. The method further comprises dividing the frequency band of at least the received data signal into a plurality of frequency sub-bands with each frequency sub-band having a bandwidth lower than that of the received data signal, estimating interference parameters from the received pilot signal for each frequency sub-band separately, suppressing the interference from the received data signal on the basis of the estimated interference parameters, and combining the frequency sub-bands in order to reconstruct an interference suppressed data signal.

According to another aspect of the invention, there is provided a radio receiver comprising a communication interface configured to receive a pilot signal and a data signal that have been transmitted according to a single carrier transmission scheme. The radio receiver further comprises a processing unit configured to divide the frequency band of at least the received data signal into a plurality of frequency sub-bands with each frequency sub-band having a bandwidth lower than that of the received data signal, to estimate interference parameters from the received pilot signal for each frequency sub-band separately, to suppress the interference from the received data signal on the basis of the estimated interference parameters, and to combine the frequency sub-bands.

According to another aspect of the invention, there is provided an interference suppression unit in a radio receiver. The interference suppression unit comprises means for receiving a pilot signal and a data signal that have been transmitted according to a single carrier transmission scheme. The interference suppression unit further comprises means for dividing the frequency band of at least the received data signal into a plurality of frequency sub-bands with each frequency sub-band having a bandwidth lower than that of the received data signal, means for estimating interference parameters from the received pilot signal for each frequency sub-band separately, means for suppressing the interference from the received data signal on the basis of the estimated interference parameters, and means for combining the frequency sub-bands.

According to another aspect of the invention, there is provided a computer program product encoding a computer program of instructions for executing a computer process for interference suppression in a radio receiver. The process comprises receiving a pilot signal and a data signal that have been transmitted according to a single carrier transmission scheme. The process further comprises dividing the frequency band of at least the received data signal into a plurality of frequency sub-bands with each frequency sub-band having a lower bandwidth than that of the received data signal, estimating interference parameters from the received pilot signal for each frequency sub-band separately, suppressing the interference from the received data signal on the basis of the estimated interference parameters, and combining the frequency sub-bands.

According to another aspect of the invention, there is provided a computer program distribution medium readable by a computer and encoding a computer program of instructions for executing a computer process for interference suppression in a radio receiver. The process comprises receiving a pilot signal and a data signal that have been transmitted according to a single carrier transmission scheme. The process further comprises dividing the frequency band of at least the received data signal into a plurality of frequency sub-bands with each frequency sub-band having a lower bandwidth than that of the received data signal, estimating interference parameters from the received pilot signal for each frequency sub-band separately, suppressing the interference from the received data signal on the basis of the estimated interference parameters, and combining the frequency sub-bands.

The invention provides several advantages. An advantage of the invention is that interference suppression may be carried out in an arbitrary small bandwidth of a frequency sub-band, and this way it is possible to reduce the number of parameters, for example channel parameters, to be estimated for the interference suppression. This reduction in the parameters leads to significant performance gains within frequency selective channels in a co-channel interference communication scenario. Another advantage from the reduction of estimated parameters is that the channel and other parameter estimators are more robust to interference and noise due to this parameter reduction.

### LIST OF DRAWINGS

In the following, the invention will be described in greater detail with reference to the embodiments and the accompanying drawings, in which

FIG. 1 shows a prior art interference rejection combining scheme;

FIG. 2A illustrates a simplified block diagram of a telecommunication system in which embodiments of the invention may be implemented;

FIG. 2B illustrates an example of an interference suppression scheme in conjunction with diversity combining;

FIG. 3 illustrates a block diagram of an interference suppression unit according to an embodiment of the invention;

FIG. 4A illustrates a block diagram of an interference suppression arrangement according to an embodiment of the invention;

FIG. 4B illustrates a block diagram of an interference suppression arrangement according to another embodiment of the invention; and

FIG. 5 is a flow diagram illustrating a process for interference suppression in a radio receiver according to an embodiment of the invention.

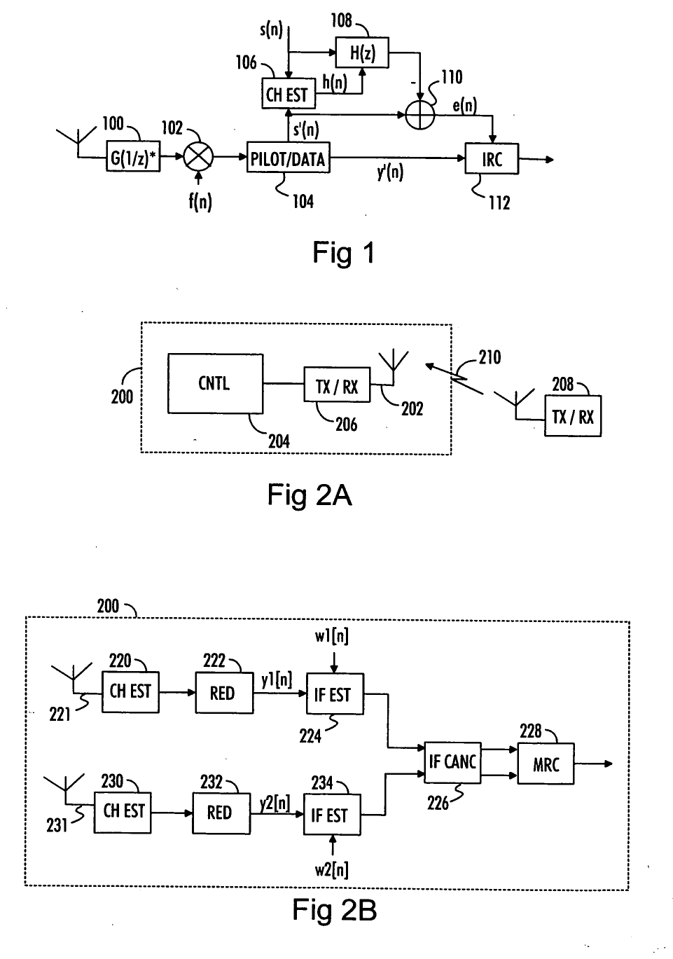

### DESCRIPTION OF EMBODIMENTS

With reference to FIG. 2A, let us examine an example of a radio receiver 200 in which embodiments of the invention can be implemented. The radio receiver 200 may be a communication device capable of transmitting and receiving radio telecommunication signals or a communication device capable of only receiving such signals. The radio receiver 200 may belong to a telecommunication system and, thus, be a network element, such as a base station of the telecommunication system. The telecommunication system may be, for example, a spread spectrum communication system in which signals are transmitted according to a single carrier transmission technology. The telecommunication system may utilize, for example, code division multiple access (CDMA) and/or frequency division multiple access (FDMA) schemes.

The radio receiver 200 comprises a communication interface 206 to receive radio signals transmitted over a communication link 210 from a radio transmitter 208, which may be a subscriber unit of the telecommunication system. The communication interface 206 may also be arranged to transmit radio signals. The communication interface 206 may comprise an antenna 202 and radio frequency (RF) components, such as a radio frequency filter, an amplifier, etc. The communication interface 206 may be configured to receive signals with diversity. The communication interface 206 may, for example, receive signals through a plurality of reception antennas 202.

The radio receiver 200 further comprises a processing unit 204 to control functions of the radio receiver 200. The processing unit 204 handles establishment, operation and termination of radio connections in the radio receiver 100. Additionally, the processing unit 204 controls reception of information by controlling the signal processing operations carried out with respect to the received radio signals. The processing unit 204 may carry out, for example, interference suppression algorithms in the radio receiver 200. The processing unit 204 may be implemented by a digital signal processor with suitable software embedded in a computer readable medium, or by separate logic circuits, for example with ASIC (Application Specific Integrated Circuit).

The radio receiver 200 may optionally further comprise other components connected to the processing unit 204, such as a user interface and one or more memory devices. These components do not, however, limit the invention in any way and are thus not described in more detail.

Reference is made to FIG. 2B, which shows one embodiment of a radio receiver implementing an interference rejection combining (IRC) scheme. The signal is received via two signal paths 221 and 231. The signal paths may represent signals received via two respective reception antennas. Alternatively, the signal paths 221 and 231 may represent signal paths obtained by over-sampling, that is, the actual signal is received by one reception antenna, but the sampling rate at the receiver is double to the transmit symbol rate. The samples may alternately be directed to the first signal path 221 and to the second signal path 231. The two signal paths 221 and 231 in FIG. 2B have only been shown as an example and there can be more than two signal paths in the radio receiver.

The signal path-specific channel estimates are formed in channel estimators 220 and 230. The channel estimates may be formed by applying pilot symbols known to the receiver, and which are present in the received data bursts. By applying the formed channel estimates, the desired signal may be reduced in reduction elements 222, 232 from the received signals, whereby the interference estimate signals y₁[n] and y₂[n] are obtained. The interference estimation may comprise calculation of an interference covariance matrix which may be calculated according to the following equation:
R=E(yy^{H}) (1)
where E denotes an expected value, y is an interference signal matrix composed of the interference estimate signals y₁[n] and y₂[n], and H denotes a complex conjugate transpose operation. The calculation of the interference covariance matrix may be carried out as is known in the art.

The interference cancellation parameters are estimated in estimation blocks 224, 234. One object of the estimation is to provide a model suitable for the subsequently following interference cancellation. Another object of the estimation is to find such parameters that fit best to the selected interference signal model.

In one embodiment, the estimation is made by a model, which takes white noise signals w₁[n] and w₂[n] as input signals and provides the interference estimate signals as output. The estimated model parameters may then be directly used as output parameters of the interference estimation blocks 224 and 234.

The actual interference cancellation is carried out in an interference cancellation block 226. The interference cancellation block 226 takes as input signals the original input data signals, received via separate receive antennas or obtained by over-sampling. Additionally, the estimation blocks 224 and 234 provide the interference cancellation block 226 with the interference cancellation parameters.

After the interference cancellation carried out in block 226, the combining of the signal paths may be carried out in a combining block 228. The combining block 228 may combine the signal paths according to a maximal ratio combining (MRC) scheme, for example. Then, the combined data signal is fed forward for further processing including data demodulation and decoding.

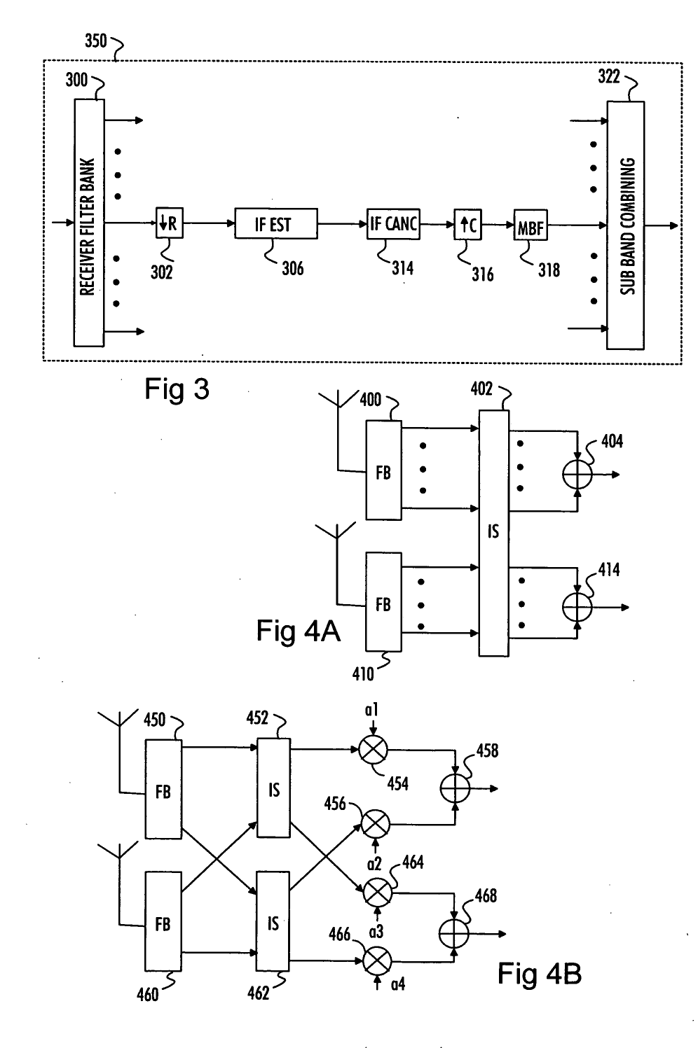

FIG. 3 illustrates an interference suppression scheme according to an embodiment of the invention carried out in the radio receiver 200. FIG. 3 illustrates an interference suppression unit 350 according to an embodiment of the invention. A signal received in the radio receiver is a single carrier signal with a given bandwidth. The received signal may be corrupted by co-channel interference caused by other users of the same frequency band, inter-symbol interference (ISI) caused by a fading radio channel, and noise which typically has a flat spectrum. The co-channel interference may occupy the whole frequency band of a desired signal or only a part of it. There may be several interfering signals in the frequency band of the desired signal.

A pilot signal and a data signal are received in the radio receiver and they are filtered with a pulse shaping filter, amplified, and A/D converted. The signals may also be converted to a base band or to an intermediate frequency. The total frequency band of the received pilot signal and the received data signal is then divided into a plurality of frequency sub-bands in a receiver filter bank 300. The receiver filter bank 300 may be a filter bank known in the art and have a corresponding structure. The receiver filter bank 300 may be, for example, a generalized discrete Fourier transform (GDFT) based filter bank or a multi-rate polyphase filter bank. The filter bank may have a perfect reconstruction property. The invention is, however, not limited to the structure of the filter bank. The number of frequency sub-bands may vary according to the desired implementation and properties of the telecommunication system and the channel. The number of frequency sub-bands is, however, two or more than two. The receiver filter bank 300 may carry out the pulse shaping operation, in which case there is no need for a separate pulse shaping filter. The receiver filter bank 300 may also convert each frequency sub-band from the intermediate frequency to a base band.

After the received pilot signal and the data signal have been divided into frequency sub-bands, each frequency sub-band may be processed separately, as FIG. 3 illustrates. FIG. 3 illustrates only detailed processing of one frequency sub-band but the same processing may be carried out with respect to the other frequency sub-band or sub-bands. Some processing may be carried out jointly for each frequency sub-band as will be described later.

Let us now consider processing of the received pilot signal and the data signal on one frequency sub-band with reference to FIG. 3. At this stage, it should be appreciated that even though description is carried out by referring to the received pilot signal and the data signal, this refers to the components of the received pilot signal and the data signal located on the frequency sub-band being processed.

Because the bandwidth of the frequency sub-band is lower than the total bandwidth of the received signal, the data rate in the frequency sub-band may be reduced and the Nyquist sampling criterion is still satisfied. Accordingly, computational burden associated with the frequency sub-band may be reduced. This is a common procedure associated with filter banks. The data rate is reduced in a decimation block 302 by decimating a number of samples from the pilot signal and the data signal. The number of samples that can be decimated depends typically on the number of frequency sub-bands.

Next, the received pilot signal with the reduced data rate is processed in an interference estimation block 306. The interference estimation block 306 may carry out the same interference estimation as described above with the reference to FIG. 2B. The interference estimation block 306 may first determine the channel impulse response signal and reconstruct a replica of the desired pilot signal without co-channel interference. This replica of the desired pilot signal is then subtracted from the received pilot signal resulting in an interference signal. The interference estimation block 306 may then estimate specific interference parameters from the interference signal and forward the interference parameters and the received data signal to an interference suppression block 314.

The interference estimation block 306 may use the received pilot signal whose frequency band has been divided into frequency sub-bands and, specifically, the component of the received pilot signal associated with the frequency sub-band being processed. Another alternative for the interference estimation block 306 is to use the received pilot signal having the original bandwidth for estimation of the interference signal and divide the interference signal into frequency sub-bands for estimation of the interference parameters. One skilled in the art may also find other implementations with respect to the order of steps in the interference parameter estimation. The known pilot signal used for estimating the channel impulse response may be processed in the radio receiver 200 beforehand. The known pilot signal may be divided into the frequency sub-bands, decimated, converted to base band, and the resulting values may be stored in a memory of the radio receiver for later use.

The interference suppression block 314 uses the interference parameters calculated by the interference estimation block 306 in order to suppress the interference from the received data signal. The interference suppression block 314 may calculate interference suppression parameters such that the frequency spectrum of the received data signal is whitened. That is, the interference suppression block 314 removes correlation from the received data signal on the basis of the interference parameters (for example the covariance matrix). The interference suppression may be carried out jointly for every frequency sub-band or separately for each frequency sub-band, as will be described later.

After the interference suppression, the data rate of the interference suppressed data signal (and the pilot signal, if necessary) is restored in an interpolation block 316. The interpolation block 316 may, for example, insert zero-valued samples between the samples of the data signal. After the data rate has been restored to match the data rate before the decimation, the interpolated data signal is filtered in a filter 318 in order to smooth the interpolated data signal. Thereafter, the frequency sub-bands may be converted from the base band into their original intermediate frequencies and combined in a sub-band combining block 322. The conversion of each sub-band from the base band to its corresponding intermediate frequency is important for the proper combining of the frequency sub-bands. The sub-band combining block 322 may simply sum the signals from each frequency sub-band together. The sub-band combining block 322 is a counterpart of the receiver filter bank 300. From the sub-band combining block 322, the data signal is fed forward for further processing, such as equalization and demodulation.

Next, two approaches to interference suppression according to embodiments of the invention will be described with the reference to FIGS. 4A and 4B. In FIGS. 4A and 4B, the signals are received with diversity which may be obtained, for example, by receiving signals with a plurality of reception antennas or by oversampling the received signals. FIGS. 4A and 4B illustrate only the blocks that are necessary for describing these embodiments of the invention.

FIG. 4A illustrates an embodiment in which interference suppression is carried out jointly for every frequency sub-band and for every diversity branch. In this case, a signal is received in two diversity branches, which are called as the main branch and the diversity branch. A received pilot signal and a data signal in the main branch are divided into frequency sub-bands in a first filter bank 400. A received pilot signal and a data signal in the diversity branch are divided into frequency sub-bands in a second filter bank 410. Then the signals in the frequency sub-bands are decimated and interference parameters are estimated as described with reference to FIG. 3. These operations are not illustrated in FIGS. 4A and 4B due to simplified description.

The interference suppression is carried out in the interference suppression block 402. The interference suppression block 402 may calculate the interference suppression parameters by assuming that the interference in the frequency sub-bands and the diversity branches is correlated (spectrally colored). Consequently, the interference suppression block 402 may calculate the interference suppression parameters in order to whiten the spectrum of the received signal on each diversity branch. The interference suppression block 402 may whiten the frequency spectrum of the received data signal by attenuating the frequency sub-bands in which severe interference is detected.

After the interference suppression, the frequency sub-bands of the main branch are combined in a first combiner 404 and the frequency sub-bands of the diversity branch are combined in a second combiner 414. The interference suppression according to the embodiment of FIG. 4A may be suitable for the filter bank structures which have considerable overlapping of transitional bands of the frequency sub-bands. In this case, there are substantial interference components that are present in two adjacent frequency sub-bands (due to overlapping transitional bands) and, thus, interference estimates related to these two adjacent frequency sub-bands have a high correlation. On the other hand, if the transitional bands of two adjacent frequency sub-bands overlap only minimally in the filter bank structure, the interference estimates for adjacent frequency sub-bands have a low correlation. For such cases, an embodiment illustrated in FIG. 4B may be less complex.

FIG. 4B illustrates an embodiment in which interference suppression is carried out for each frequency sub-band separately. The respective frequency sub-bands of the main branch and the diversity branch may be processed jointly. In FIG. 4B, the total frequency band of the received pilot and data signal is divided only into two frequency sub-bands for the sake of simplicity of the description. The total frequency band of the received pilot and data signal in the main branch is divided into a first and a second frequency sub-band in a first filter bank 450. The total frequency band of the received pilot and data signal in the diversity branch is divided into a third and a fourth frequency sub-band in a second filter bank 460. The first and the third frequency sub-band relate to the same frequency band and they are forwarded to a first interference suppression block 452. The second and the fourth frequency sub-band relate to the same frequency band and they are forwarded to a second interference suppression block 462. The first and the second interference suppression block 452 and 462 may estimate the interference suppression parameters for respective frequency sub-bands by utilizing the correlation in the interference estimate related to the diversity branches of the respective frequency sub-bands. Again, the interference suppression blocks 452 and 462 attempt to whiten the frequency spectrum of the received data signal.

The frequency sub-bands of the main branch are combined in a first combiner 458 and the frequency sub-bands of the diversity branch are combined in a second combiner 468. Before the combining, each frequency sub-band is adjusted with a weighting factor. This may be done in order to mitigate interference in the overlapping transitional bands of two adjacent frequency sub-bands. The frequency sub-bands may be adjusted by multiplying the signals in the frequency sub-bands by suitable weighting factors a1, a2, a3, and a4 in multipliers 454, 456, 464, and 466, respectively. The weighting factors may be calculated according to a specific criterion. The criterion may be to minimize the interference power, to maximize the desired signal power, or to maximize the signal-to-interference power ratio (SINR). The weighting related to the frequency sub-bands may also be applied to the embodiment of FIG. 4A but it may not be necessary.

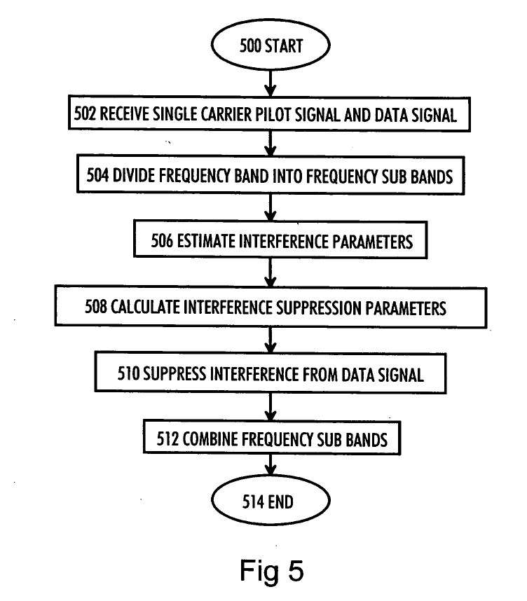

Next, a process for interference suppression in a radio receiver is described with the reference to a flow diagram of FIG. 5. The process starts in block 500. In block 502, a pilot signal and a data signal are received in the radio receiver. The pilot signal and the data signal may be received with diversity. The received pilot signal and the data signal have been transmitted by utilizing a single carrier data transmission scheme. In block 504, at least the received data signal is divided into frequency sub-bands. The division may be carried out with a filter bank structure in the radio receiver. Depending on the implementation, the pilot signal may also be divided into frequency sub-bands in this step.

The received pilot signal and the data signal may be corrupted with co-channel interference in a radio channel. Specific interference parameters are estimated in block 506. The interference parameters may be estimated from the received pilot signal. Prior to the estimation of the interference parameters, the inter symbol interference may be mitigated from the received pilot signal. The interference estimation may be carried out for each frequency sub-band separately.

After the interference parameters have been estimated, interference suppression parameters are calculated in block 508 on the basis of the estimated interference parameters. The interference suppression parameters may be calculated for each frequency sub-band and diversity branch separately or jointly for every frequency sub-band and/or diversity branch. Then, the interference may be suppressed from each frequency sub-band by applying the calculated interference suppression parameters. The interference suppression is carried out in block 510. After the interference suppression, the frequency sub-bands are combined in block 512. The process ends in block 514.

The embodiments of the invention may be realized in a radio receiver 200 comprising a processing unit 204 configured to carry out interference suppression to received signals. The processing unit 204 may be configured to perform at least some of the steps described in connection with the flowchart of FIG. 5 and in connection with FIGS. 2B, 3, 4A and 4B. The embodiments may be implemented as a computer program comprising instructions for executing a computer process for interference suppression in the radio receiver 200.

The computer program may be stored on a computer program distribution medium readable by a computer or a processor. The computer program medium may be, for example but not limited to, an electric, magnetic, optical, infrared or semiconductor system, device or transmission medium. The computer program medium may include at least one of the following media: a computer readable medium, a program storage medium, a record medium, a computer readable memory, a random access memory, an erasable programmable read-only memory, a computer readable software distribution package, a computer readable signal, a computer readable telecommunications signal, computer readable printed matter, and a computer readable compressed software package.

Even though the invention has been described above with reference to an example according to the accompanying drawings, it is clear that the invention is not restricted thereto but it can be modified in several ways within the scope of the appended claims.

1. An interference suppression method in a radio receiver, the method comprising:
receiving a pilot signal and a data signal that have been transmitted according to a single carrier transmission scheme;
dividing a frequency band of at least the received data signal into a plurality of frequency sub-bands with each of the plurality of frequency sub-bands having a bandwidth lower than that of the received data signal;
estimating interference parameters from the received pilot signal for each of the plurality of frequency sub-bands separately;
suppressing interference from the received data signal on the basis of the estimated interference parameters; and
combining the plurality of frequency sub-bands in order to reconstruct an interference suppressed data signal.

2. The method of claim 1, further comprising reducing a data rate of the data signal on each frequency sub-band to be lower than a data rate of the received the data signal.

3. The method of claim 1, wherein the division of the frequency band of at least the received data signal into a plurality of frequency sub-bands is carried out by using a filter bank.

4. The method of claim 1, the estimation of the interference parameters comprising:
estimating a channel impulse response signal from the received pilot signal associated with a frequency sub-band under consideration;
applying the channel impulse response signal to a known transmitted pilot signal, thus producing a replica of a pilot signal propagated through the channel;
producing a co-channel interference signal by subtracting the replica of the pilot signal from the received pilot signal; and
calculating covariance information of the interference from the co-channel interference signal.

5. The method of claim 1, wherein the suppression of the interference comprises whitening a frequency spectrum of the received data signal.

6. The method of claim 1, wherein the pilot signal and the data signal are received with diversity, the method further comprising:
performing the division by dividing the frequency band of the received pilot signal and the data signal of each diversity branch into the plurality of frequency sub-bands;
performing the estimation of the interference parameters from the received pilot signal for each frequency sub-band and each diversity branch separately;
performing the suppression of the interference from the received data signal on the basis of an estimated interference component; and
performing the combination the frequency sub-bands of respective diversity branches.

7. The method of claim 6, further comprising suppressing the interference from the received data signal jointly for every frequency sub-band and diversity branch.

8. The method of claim 6, further comprising:
suppressing the interference from the received data signal separately for each frequency sub-band;
calculating a weighting factor for each frequency sub-band;
multiplying the data signal of each frequency sub-band with a corresponding weighting factor; and
combining the frequency sub-bands of each diversity branch.

9. The method of claim 8, wherein the suppression of the interference is carried out jointly for every diversity branch associated with the respective frequency sub-bands.

10. A radio receiver comprising:
a communication interface configured to receive a pilot signal and a data signal that have been transmitted according to a single carrier transmission scheme; and
a processing unit configured to divide a frequency band of at least the received data signal into a plurality of frequency sub-bands with each frequency sub-band having a bandwidth lower than that of the received data signal, to estimate interference parameters from the received pilot signal for each frequency sub-band separately, to suppress interference from the received data signal on the basis of estimated interference parameters, and to combine the plurality of frequency sub-bands.

11. The radio receiver of claim 10, wherein the processing unit is further configured to reduce a data rate of the data signal on each frequency sub-band to be lower than a data rate of the received the data signal.

12. The radio receiver of claim 10, wherein the processing unit is further configured to divide the frequency band of at least the data signal into the plurality of frequency sub-bands by using a filter bank.

13. The radio receiver of claim 10, wherein the processing unit is further configured to estimate a channel impulse response signal from the received pilot signal, to apply the channel impulse response signal to a known transmitted pilot signal, thus producing a replica of a pilot signal propagated through a channel, to produce a co-channel interference signal by subtracting the replica of the pilot signal from the received pilot signal, and to calculate a covariance information of the interference from the co-channel interference signal.

14. The radio receiver of claim 10, wherein the processing unit is further configured to suppress the interference parameters by whitening a frequency spectrum of the received data signal.

15. The radio receiver of claim 10 wherein the communication interface is configured to receive the pilot signal and the data signal with diversity and that the processing unit is further configured to divide a frequency band of the received pilot signal and the data signal of each diversity branch into a plurality of frequency sub-bands, to estimate interference parameters from the received pilot signal for each frequency sub-band and each diversity branch separately, to suppress the interference parameters from the received data signal on the basis of the estimated interference parameters, and to combine the frequency sub-bands of respective diversity branches.

16. The radio receiver of claim 15 wherein the processing unit is further configured to suppress the interference parameters from the received data signal jointly for every frequency sub-band and diversity branch.

17. The radio receiver of claim 15 wherein the processing unit is further configured to suppress the interference parameters separately for each frequency sub-band, to calculate a weighting factor for each frequency sub-band, to multiply the data signal of each frequency sub-band with a corresponding weighting factor, and to combine the frequency sub-bands of each diversity branch.

18. The radio receiver of claim 17 wherein the processing unit is further configured to suppress the interference jointly for every diversity branch associated with the respective frequency sub-bands.

19. An interference suppression unit in a radio receiver, the interference suppression unit comprising:
means for receiving a pilot signal and a data signal that have been transmitted according to a single carrier transmission scheme;
means for dividing a frequency band of at least the received data signal into a plurality of frequency sub-bands with each of the plurality of frequency sub-bands having a bandwidth lower than that of the received data signal;
means for estimating interference parameters from the received pilot signal for each of the plurality of frequency sub-bands separately;
means for suppressing interference from the received data signal on the basis of the estimated interference parameters; and
means for combining the plurality of frequency sub-bands.

20. A radio receiver comprising:
means for receiving a pilot signal and a data signal that have been transmitted according to a single carrier transmission scheme;
means for dividing a frequency band of at least the received data signal into a plurality of frequency sub-bands with each of the plurality of frequency sub-bands having a bandwidth lower than that of the received data signal;
means for estimating interference parameters from the received pilot signal for each of the plurality of frequency sub-bands separately;
means for suppressing interference from the received data signal on the basis of the estimated interference parameters; and
means for combining the plurality of frequency sub-bands.

21. A computer program distribution medium readable by a computer and encoding a computer program of instructions for executing a computer process for interference suppression in a radio receiver, the process comprising:
receiving a pilot signal and a data signal that have been transmitted according to a single carrier transmission scheme;
dividing a frequency band of at least the received data signal into a plurality of frequency sub-bands with each of the plurality of frequency sub-bands having a bandwidth lower than that of the received data signal;
estimating interference parameters from the received pilot signal for each of the plurality of frequency sub-bands separately;
suppressing interference from the received data signal on the basis of the estimated interference parameters; and
combining the frequency sub-bands.

22. The computer program distribution medium of claim 21, the distribution medium including at least one of the following media: a computer readable medium, a program storage medium, a record medium, a computer readable memory, a computer readable software distribution package, a computer readable signal, a computer readable telecommunications signal, and a computer readable compressed software package.
